(19) United States
(12) Patent Application Publication
(10) Pub. No.: US 2018/0042260 A1
(43) Pub. Date: Feb. 15, 2018

(54) NEW COLOR FOR EDIBLE COATINGS

(71) Applicant: DSM IP ASSETS B.V., Heerlen (NL)

(72) Inventors: Hansjoerg GRASS, Kaiseraugst (CH); Andrea HITZFELD, Kaiseraugst (CH)

(21) Appl. No.: 15/559,568

(22) PCT Filed: Mar. 24, 2016
(86) PCT No.: PCT/EP2016/056536

§ 371 Date: Sep. 19, 2017

Related U.S. Application Data
(60) Provisional application No. 62/138,681, filed on Mar. 26, 2015.

(51) Int. Cl. A23G 1/54; A23L 29/30; A23L 5/44; A23L 29/212; A23G 3/34; A23G 3/54

(52) U.S. Cl. CPC A23G 1/54; A23G 3/343; A23G 3/54; A23L 5/44; A23L 29/212; A23L 29/30; A23V 2002/00

(57) ABSTRACT

The present invention is directed to an edible coating comprising milled rhodoxanthin having an average particle size D(v,0.5) in the range of from 400 to 650 nm, more preferably in the range of from 500 nm to 600 nm, measured by Laser Diffraction; Malvern Mastersizer 3000, MIE volume distribution. This milled rhodoxanthin is preferably added to the edible coating during its manufacture in the form of a dispersion. The edible coating is preferably used for coating confectionary such as chocolate lentils. The present invention is also directed to precursors of such edible coatings such as sugar syrup and sugar-free alternatives, both comprising such a milled rhodoxanthin.

The present invention is directed to edible coatings with a rose to purple color shade which are e.g. used for confectionaries such as in particular chocolate products. The present invention is further directed to the precursors of such edible coatings, i.e. the sugar syrup or the sugar-free syrup, as well as to panned confection and a process for its manufacture.

There is increasing interest in the food industry to replace artificial materials for coloring foods with natural or nature identical colorants. Artificial materials such as azo dyes are suspected of causing attention deficit hyperactivity disorder (ADHD) in children. Furthermore such dyes can trigger allergies and allergy-like syndroms. Thus, due to the increased health consciousness of consumers there is a trend towards the use of natural dyes or nature identical colors. Especially wanted are colors that are also animal-free and kosher/halal.

A challenge in replacing artificial colorants with natural colorants in the coating of hard panned confections has been in obtaining the stability of color characteristics provided by artificial colorants and to match the color of the product the consumer is already used to. Thus, it is important that a consistent visual quality of the product is guaranteed.

Surprisingly it has been found that rhodoxanthin can be used to impart a rose to purple color shade to edible coatings.

Thus, the present invention is directed to an edible coating comprising a milled rhodoxanthin form, wherein the milled rhodoxanthin in the form has an average particle size D(v,0.5) in the range of from 400 to 650 nm, more preferably in the range of from 500 nm to 600 nm, measured by Laser Diffraction; Malvern Mastersizer 3000, MIE volume distribution. Surprisingly such edible coatings have a rose to purple color which could not be expected since rhodoxanthin itself has a red color. This edible coating can be applied to any desired edible product center.

### Edible Product Center

The edible product centers may be classified as follows: soft, hard, filled, extruded and compressed edible product centers.

Examples of soft edible product centers are deposited products based on Gum Arabic, gelatin, agar agar and/or pectin; toffee mass; deposited foam and fondant.

Examples of hard edible product centers are hard boiled candy, all types of nuts (e.g. almonds, peanuts, hazelnuts) and recrystallized candy mass.

Examples of filled edible product centers are crusted liquid filling (coffee beans, easter eggs), soft candy with powder filling and soft candy with semi liquid filling.

Examples of extruded edible product centers are expanded cereals, original liquorice and fruit liquorice.

Examples of compressed edible product centers are all type of mint and fruit tablets, as well as drug delivery systems.

The edible product center may also be characterized according to the material it is made of. Therefore, in some embodiments, the edible product center may comprise a natural center, e.g., a nut (e.g. almonds, peanuts, hazelnuts), a nut paste, a fruit (e.g. a date), a dried fruit (e.g. dried apricots or raisins) or dried fruit pieces, or dried fruit paste, or spices (e.g. coriander, ginger, anisette seeds). The edible product center may also be sugar crystals.

Or, the edible product center may comprise a confection, e.g., a boiled sugar syrup, caramel, nougat, toffee, marshmallows, fudge, chocolate, or combinations of these.

Alternatively, the edible product center may comprise a grain-based item such as cereals (e.g. oat, wheat, corn, rice), especially e.g. a grain-based item in form of a cookie, pretzel, biscuit, wafer, cracker, or other baked, crisped, or puffed material.

The edible product center may also be a tablet or a chewing gum. Examples of a tablet are a pharmaceutical or a (multi)vitamin tablet or a (multi)mineral tablet or a mixture thereof. The chewing gum can be in the form of balls, pillows or compressed tablets.

The present invention also encompasses edible product centers with any combination of preferred features of the edible product centers as disclosed above though not explicitly mentioned.

### Edible Coating

Preferably the milled rhodoxanthin form is a dispersion. More preferably the milled rhodoxanthin in such a dispersion is encapsulated in a matrix of modified food starch. The present invention is therefore also directed to such dispersions and other forms of milled rhodoxanthin with the particle size as given above and to the manufacture of such milled forms, especially such milled dispersions. Such forms will be explained in more detail below.

In such forms the rhodoxanthin is protected from degradation and oxidation.

### Rhodoxanthin

Rhodoxanthin (compound of formula I) can be obtained from a natural source, by fermentation or by chemical synthesis. A natural source might be conifers, e.g. plants of Taxus baccata, or Aloe sp. (see e.g. Merzlyak et al., Photochem. Photobiol. Sci. 2005, 4, 333-340). Chemical syntheses are e.g. described in EP-A 077 439 and EP-A 085 763.

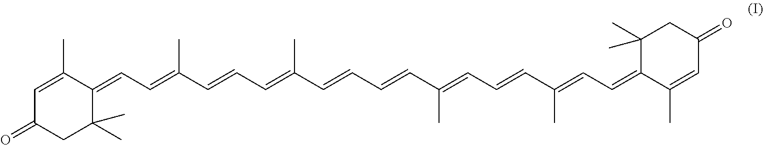 [SMILES: CC1=CC(=O)CC(C)(C)\C1=C/C=C(C)/C=C/C=C(C)/C=C/C=C/C(C)=C/C=C/C(C)=C/C=C1/C(C)=CC(=O)CC1(C)C]

The term “rhodoxanthin” used herein encompasses the (all-E)-isomer as well as mono-, oligo- or poly-(Z)-isomers. A preferred isomer mixture contains (all-E)-rhodoxanthin, (6Z)-rhodoxanthin and (6Z,6′Z)-rhodoxanthin.

### Amount of Rhodoxanthin in the Edible Coating

Preferably the amount of rhodoxanthin in the edible coating is in the range of from 2 ppm to 100 ppm, more preferably it is in the range of from 10 ppm to 80 ppm, most preferably it is in the range of from 20 ppm to 60 ppm, based on the total weight of the edible coating.

### Milled Rhodoxanthin Dispersion

The liquid of such a dispersion according to the present invention is water.

The average particle size D (v,0.5) of the milled rhodoxanthin in such dispersion is preferably in the range of from 400 nm to 650 nm, more preferably in the range of from 500 nm to 600 nm, measured by Laser Diffraction; Malvern Mastersizer 3000, MIE volume distribution.

When the color of such milled dispersion is measured at the CIELAB color scale it has a color value b* in the range of from −7.5 to 0, preferably it has a color value b* in the range of from −2.5 to 0, more preferably it has a color value b* in the range of from −2.0 to −0.5. The color value h of such milled dispersion is preferably in the range of from 350 to 360, more preferably it is in the range of from 352 to 356, most preferably it is in the range of from 353 to 355.

In the dispersion according to the present invention the milled rhodoxanthin is preferably embedded in a matrix of a modified food starch. The amount of the milled rhodoxanthin in the dispersion is usually in the range of from 1 to 15 weight-%, based on the total weight of the dispersion. The modified food starch (esp. OSA starch) and mixtures thereof are described in more detail below. Additionally one or more water- and/or fat-soluble antioxidants may be present, preferably in an amount of from 0.5 to 5 weight-% in total, based on the total amount of the dispersion.

A preferred example of such water-soluble antioxidants is sodium ascorbate.

A preferred example of such fat-soluble antioxidants is dl-alpha-tocopherol.

Especially preferred is a dispersion where the milled rhodoxanthin is embedded in a matrix of modified food starch, whereby glycerine or a saccharide is added. An especially preferred example of such a dispersion is described in the examples.

Milled Rhodoxanthin Dispersion Comprising Milled Rhodoxanthin, Modified Food Starch, Glycerine, Water and Optionally (a) Water- and/or Fat-Soluble Antioxidant/s

When glycerine is present, the amounts of water and glycerine are preferably both in the range of from 30 to 40 weight-%, based on the total weight of the dispersion, and the amount of modified food starch is preferably in the range of from 10 to 25 weight-%, based on the total weight of the dispersion, whereby the amounts of milled rhodoxanthin, modified food starch, glycerine, water and, if present, water- and/or fat-soluble antioxidants all sum up to 100 weight-%.

Milled Rhodoxanthin Dispersion Comprising Milled Rhodoxanthin, Modified Food Starch, Water, Saccharide and Optionally (a) Water- and/or Fat-Soluble Antioxidant/s

When a saccharide is present, the amount of the saccharide is preferably in the range of from 2 to 65 weight-%, the amount of modified food starch is preferably in the range of from 15 to 45 weight-%, and the amount of water is preferably in the range of from 5 to 50 weight-%, all amounts being based on the total weight of the dispersion, whereby the amounts of milled rhodoxanthin, modified food starch, saccharide, water and, if present, water- and/or fat-soluble antioxidants all sum up to 100 weight-%.

The term “a saccharide” encompasses one saccharide or more.

The term “saccharide” in the context of the present invention encompasses mono-, di-, oligo- and polysaccharides, as well as any mixtures thereof.

Examples of monosaccharides are fructose, glucose (=dextrose), mannose, galactose, sorbose, as well as any mixtures thereof.

Preferred monosaccharides are glucose and fructose, as well as any mixture thereof.

The term “glucose” in the context of the present invention does not only mean the pure substance, but also a glucose syrup with a DE 90. This also applies for the other monosaccharides.

The term “dextrose equivalent” (DE) denotes the degree of hydrolysis and is a measure of the amount of reducing sugar calculated as D-glucose based on dry weight; the scale is based on native starch having a DE close to 0 and glucose having a DE of 100.

Examples of disaccharides are saccharose, isomaltose, lactose, maltose and nigerose, as well as any mixture thereof.

An example of an oligosaccharide is maltodextrin.

An example of a polysaccharide is dextrin.

An example of a mixture of mono- and disaccharides is invert sugar (glucose+fructose+saccharose).

Mixtures of mono- and polysaccharides are e.g. commercially available under the tradenames Glucidex IT 47 (from Roquette Freres), Dextrose Monohydrate ST (from Roquette Freres), Sirodex 331 (from Tate a Lyle), Glucamyl F 452 (from Tate a Lyle) and Raftisweet I 50/75/35 (from Lebbe Sugar Specialties).

The most preferred saccharides are a glucose syrups or invert sugar syrups.

### Other Milled Rhodoxanthin Forms According to the Present Invention

Instead of a dispersion also solid forms may be used. These can be easily produced e.g. by spray-drying the dispersion which contains a saccharide such as preferably a glucose syrup or an invert sugar syrup.

The present invention also encompasses rhodoxanthin forms with any combination of preferred features of these forms as disclosed in this patent application though not explicitly mentioned.

### “Modified Food Starch”

A modified food starch is a food starch that has been chemically modified by known methods to have a chemical structure which provides it with a hydrophilic and a lipophilic portion. Preferably the modified food starch has a long hydrocarbon chain as part of its structure (preferably C5-C18).

At least one modified food starch is preferably used to make a formulation of this invention, but it is possible to use a mixture of two or more different modified food starches in one formulation.

Starches are hydrophilic and therefore do not have emulsifying capacities. However, modified food starches are made from starches substituted by known chemical methods with hydrophobic moieties. For example starch may be treated with cyclic dicarboxylic acid anhydrides such as succinic anhydrides, substituted with a hydrocarbon chain (see O. B. Wurzburg (editor), “Modified Starches: Properties and Uses, CRC Press, Inc. Boca Raton, Fla., 1986, and subsequent editions). A particularly preferred modified food starch of this invention has the following formula (I)

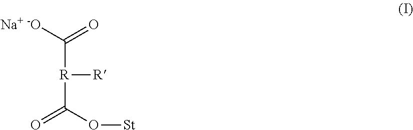

wherein St is a starch, R is an alkylene radical and R′ is a hydrophobic group. Preferably R is a lower alkylene radical such as dimethylene or trimethylene. R′ may be an alkyl or alkenyl group, preferably having 5 to 18 carbon atoms. A preferred compound of formula (I) is an “OSA-starch” (starch sodium octenyl succinate). The degree/extent of substitution, i.e. the number of esterified hydroxyl groups to the number of free non-esterified hydroxyl groups usually varies in a range of from 0.1% to 10%, preferably in a range of from 0.5% to 4%, more preferably in a range of from 3% to 4%.

The term “OSA-starch” denotes any starch (from any natural source such as corn, waxy maize, waxy corn, wheat, tapioca and potato or synthesized) that was treated with octenyl succinic anhydride (OSA). The degree/extent of substitution, i.e. the number of hydroxyl groups esterified with OSA to the number of free non-esterified hydroxyl groups usually varies in a range of from 0.1% to 10%, preferably in a range of from 0.5% to 4%, more preferably in a range of from 3% to 4%. OSA-starches are also known under the expression “modified food starch”.

The term “OSA-starches” encompasses also such starches that are commercially available e.g. from National Starch/Ingredion under the tradenames HiCap 100, Capsul, Capsul HS, Purity Gum 2000, Clear Gum Co03, UNI-PURE, HYLON VII; from National Starch/Ingredion and Roquette Freres, respectively; from CereStar under the tradename C*EmCap or from Tate a Lyle.

In an embodiment of the present invention a commercially available modified food starch such as e.g. HiCap 100 (from National Starch/Ingredion) and ClearGum Co03 (from Roquette Freres) is used.

As already stated above dispersions that contain either glycerine or a saccharide (preferably a glucose syrup or an invert sugar syrup) are preferred. Thus, their process for manufacture is now described.

### Processes of the Present Invention

The present invention is also directed to a process for the manufacture of a dispersion as described above comprising the following steps:
a) Providing a dispersion comprising crystalline rhodoxanthin, modified food starch, water and glycerine or a saccharide;
b) Milling the dispersion as obtained in step a) until the milled rhodoxanthin in the dispersion has an average particle size D(v,0.5) in the range of from 400 to 650 nm, more preferably in the range of from 500 nm to 600 nm, measured by Laser Diffraction; Malvern Mastersizer 3000, MIE volume distribution.

The steps are now described in detail below.

### Step a)

The amounts of the milled rhodoxanthin, modified food starch, water and glycerine or saccharide are chosen in such a way that a dispersion results with the preferred weight percentages as given above.

### Step b)

The milling may be carried out with any device known to the person skilled in the art such as colloid mills and ball mills.

The edible coating according to the present invention can be one being based on sugar but also one being based on sugar-free alternatives.

Preferably the edible coating of the present invention has a red value a* in the range of from 15 to 25 at the CIELAB Color scale, preferably it has a red value a* in the range of from 17 to 23 at the CIELAB Color scale, more preferably it has a red value a* in the range of from 18 to 22 at the CIELAB Color scale.

In another preferred embodiment the color shade h of the edible coating comprising milled rhodoxanthin is preferably in the range of from 2 to 10 at the CIELAB Color scale, more preferably the color shade h is in the range of from 4 to 9 at the CIELAB Color scale.

In a further preferred embodiment the edible coating of the present invention has a color value b* in the range of from 1 to 5 at the CIELAB Color scale, preferably it has a color value b* in the range of from 1 to 3 at the CIELAB Color scale.

The present invention also encompasses edible coatings with milled rhodoxanthin with any combination of preferred features of these coatings as disclosed in this patent application though not explicitly mentioned.

### Sugar-Based Edible Coatings

Preferably the sugar in the edible coating is selected from the group consisting of monosaccharides and disaccharides and mixtures thereof.

Preferred examples of mono- and disaccharides are saccharose, glucose, fructose, maltose and mixtures thereof.

The sugar syrup has preferably a Brix value in the range of from 65 to 75, more preferably it has a Brix value in the range of from 70 to 75.

When the edible coating is a hard panned coating, the sugar syrup may also include other components conventionally used in hard panned coatings. Many such components are known in the art and include, but are not limited to, sugar alcohols, high intensity sweeteners, natural polymers, flavors, flavor modifiers, gums, vitamins, minerals, nutraceuticals, or combinations of these. For example, a gum may be included in a sugar syrup to act as a plasticizer in the crystallized sugar coating.

### Sugar-Free Alternatives

Sugar-free edible coatings are also part of the present invention. Here polyols such as maltitol, xylitol, mannitol, sorbitol, isomalt, palatinose and mixtures thereof are used instead of sugar.

### Product

The present invention is directed to the edible coating as described above and claimed in the claims.

Furthermore, the present invention is also directed to a sugar syrup comprising a milled rhodoxanthin form with the average particle size as given above, preferably comprising a dispersion as described above, wherein the sugar is selected from the group consisting of monosaccharides and disaccharides and mixtures thereof. Preferably the sugar is selected from the group consisting of saccharose (=sucrose), glucose, fructose, maltose and mixtures thereof.

The same preferences as given above for the edible coating such as e.g. amount of rhodoxanthin etc. also apply for the sugar syrup.

The present invention is also directed to a sugar-free syrup comprising a milled rhodoxanthin form with the average particle size as given above, preferably comprising a dispersion as described above, and a polyol, wherein the polyol is selected from the group consisting of maltitol, xylitol, mannitol, sorbitol, isomalt, palatinose and mixtures thereof.

The same preferences as given above for the edible coating such as e.g. amount of rhodoxanthin etc. also apply for the sugar-free syrup.

The invention is also directed to a panned confection comprising:
a) an edible product center as described above, and
b) and edible coating with the preferences as described above.

The same preferences as given above for the edible coating such as e.g. amount of rhodoxanthin, amount of modified food starch, amount of water-/fat-soluble antioxidant, amount of saccharide etc. also apply for the panned confection.

The same preferences as given above for the edible product center such as type of the edible product center and material of the edible product center etc. also apply for the panned confection.

The present invention also encompasses any combination of any preferred feature of the edible coating as mentioned in this patent application with any preferred feature of the edible product center as mentioned in this patent application though not explicitly mentioned.

### Processes of the Present Invention

Prior to the application of one or more sugar syrup layers, the surface of the edible product center may be prepared according to known techniques in the art such as gumming, isolating, and stabilizing.

For example, in gumming, layers of a high glucose content syrup containing a gum, gelatin, starch, or dextrin may be applied directly to the edible center alternately with a fine crystalline sugar to fill irregularities and smooth ridges. The smoother surface that is obtained may facilitate even coating and adherence of the later applied sugar syrup layers.

Isolating is a process of creating a barrier to lipid, water, or natural sugar migration between the edible center and the sugar syrup layers, and may be effected by applying a film containing gelatin or gum to the center in a process similar to gumming. Stabilizing may be required to strengthen a fragile edible center for subsequent hard pan coating with sugar syrups. A cookie center, for example, may be prevented from crumbling during hard pan coating by first being coated with a melted fat, then isolated with a gum-containing film. Preparation of the surface of the edible core may also be completed with one or more applications of a saccharose sugar syrup.

In some embodiments, sugar syrups may be applied as coating layers directly to the surface of an edible product center. In other embodiments, sugar syrups may be applied as coating layers to a prepared surface of an edible product center, wherein the surface has been prepared according to a known technique including, but not limited to, gumming, isolating, and stabilizing. In still other embodiments, sugar syrups may be applied as coating layers to a crystallized sugar syrup layer overlying any number of coating layers overlying the edible product center. As the phrase that follows in quotation marks is used herein, the application of a sugar syrup as a coating layer “to an edible product center” does not necessarily denote that the sugar syrup is applied directly to the edible product center.

Rather, a sugar syrup that is applied as a coating layer “to an edible product center” may be applied directly to the surface of the edible product center, or to a prepared surface of an edible product center, or to a crystallized sugar syrup layer overlying any number of coating layers overlying the edible product center, within the meaning of the phrase.

In another aspect, the present invention is directed to a method of hard pan coating an edible product center comprising applying a plurality of coating layers to the edible product center, wherein applying comprises applying a coating layer comprising a sugar and a milled rhodoxanthin form to the edible product center.

The colored coating layers containing the milled rhodoxanthin form may be applied in 10 to 30 colored coating layers. Preferably a minimum of 70 coating layers of sugar syrups and 10 layers of titanium dioxide have been applied before the colored coating layers containing the milled rhodoxanthin form are applied. That means that preferably a total amount of 100 to 150 coating layers is applied.

The desired edible product center is coated with the desired sugar syrups as coating layers, in the desired number of layers for each as described above, and according to processes and techniques generally known in the art. Generally speaking, the process for manufacturing hard panned confections comprises the deposition of a plurality of coating layers of the sugar syrups, by a series of syrup application and drying cycles carried out, for example, in a rotating pan.

Panning and some coating processes are performed in a rotating drum or “pan”. Such processes may typically be driven by the equipment utilized to perform them, which are e.g. commercially available from Friedhelm Stechel GmbH (Germany), from Wolf Spezialmaschinen (Germany) and from Driam Anlagenbau Gmbh (Germany), Dumoulin (France).

In a hard panning process, multiple applications of a highly concentrated sugar syrup are used to build up the uncolored portion of a sugar coating on an edible product center. This is followed by multiple applications of a concentrated sugar syrup containing a milled rhodoxanthin form with the average particle size as given above. The hard panning process comprises the repetitive application of thin layers of a coating solution or composition onto an intermixed mass of centers, while mixing the mass of centers, and the drying of each layer of coating solution or composition during which the sugar in the coating crystallizes between the applications of layers. However, in each process, coating material is built up on the center to form the desired coating.

As the coating is to be colored with a rose to purple shade, a milled rhodoxanthin form with the average particle size as given above is added to the coating solution in the later stages of the coating process. For a hard panned confectionery, following the application of a number of layers of the uncolored sugar syrup to build up the sugar coating, a number of applications of a sugar syrup comprising a milled rhodoxanthin form with the average particle size as given above are applied to provide the color coat.

The coating layers of the hard panned confection may be applied to any desired edible product center as described above.

In another aspect, the present invention is directed to a method of soft pan coating an edible product center as described above.

### Soft Pan Coating

Soft pan coating or also called “soft panning” involves applying a syrup to the edible product centers in the same way as for hard panning; however, the soft panning syrup is intended not to crystallize. Therefore, either glucose or a mixture of sucrose and glucose is used as soft panning syrup.

The centers are wetted with the syrup just sufficiently to coat them. Instead of evaporating the water as in hard panning, powdered sugar or caster sugar is added during the tumble which is dissolving in the water of the applied syrup. The amount of sugar that is added needs to be just sufficient to coat the centers but has not to be in excess. Soft panning is carried out without heating and without the use of drying air. Soft panning is a much more rapid process then hard panning and can be applied to a soft center that will be unsuitable for hard panning. Soft panning puts on thicker layers than hard panning and consequently the shape of the centers will be lost. A product that has been soft panned can be finished by dusting with milled sugar followed by a number of hard panned coats. Typical soft panned products are jelly beans and dolly mixture components. Typically 3 to 10 layers are added in soft panning.

### Use According to the Present Invention

The present invention is also directed to the use of the milled rhodoxanthin form according to the present invention for coloring sugar syrups, sugar-free syrups and edible coatings with a purple color.

### Color Measurement

Color (lightness, Chroma, and hue) of the hard sugar coated confectionary was determined with a HunterLab Ultra Scan Pro spectrocolorimeter (Hunter Associates Laboratory, Reston, Va., USA) and expressed on basis of the CIELAB colour scale. The mode used was RSIN which stands for Reflectance—Specular Included. The small area view (SAV) with a diameter of 4.826 mm (0.190 inch) was chosen. Color measurements are carried out after CIE guidelines (Commission International d'Eclairage). Values can be expressed as planar coordinates as L*, a*, b* with L* being the measuring values for lightness, with a* being the value on the red-green axes and b* being the value on the yellow-blue axes.

The Chroma (C*) sometimes called saturation describes the vividness or dullness of a color which can be calculated as followed:

C*=√(a*²+b*²)

The angle called hue (h) describes how we perceive an object's color and can be calculated as followed:

h=tan(b/a)⁽⁻¹⁾

### Instruments Settings:

Color scale is the CIE L*a*b*/L*C*h
Light source definition: D65 daylight equivalent
Geometry: Diffuse/8°
Wavelength: scan 350-1050 nm
Sample measurement area diameter: 4.826 mm
Calibration mode: Reflection/Specular-included

The invention is now further illustrated in the following non-limiting examples.

### EXAMPLES

### Example 1: Manufacture of a Milled Rhodoxanthin Dispersion According to the Present Invention

109.1 g of modified food starch (Capsul HS) and 202.6 g of glycerine were dissolved at 60° C. in 202.6 g of water. To this solution 30 g of crystalline rhodoxanthin and 1.1 g of dl-apha-tocopherol were added.

The resulting coarse aqueous rhodoxanthin dispersion has then been milled by passing it continuously through the milling chamber of the Dispermate SL 603 agitated ball mill until the desired particle size (approx. 600 nm (average value)) has been achieved (“so called wet milling process”). The physical properties of the resulting rhodoxanthin dispersion are listed in the following:

Content of milled rhodoxanthin in the dispersion determined by HPLC=5.4%

Content of milled rhodoxanthin in the dispersion determined by UV=5.1%

E1/1_{corr.} in H₂O(λₘₐₓ)=400(498 nm)

The color intensity E1/1 is the absorbance of a 1% solution and a thickness of 1 cm and is calculated as follows: E1/1=(Amax-A650)*dilution factor/(weight of sample*content of product form in %).

“(Amax-A650)” means the value you get when you substract the Adsorption value measured at 650 nm (“A650”) wavelength from the value (“Amax”) that was measured at the maximum Adsorption in the UV-Spectrophotometer. “*” means “multiplied with”.

“dilution factor”=the factor by which the solution has been diluted.

“weight of sample”=the amount/weight of the formulation that was used in [g]

“content of product form in %”=“the amount of milled rhodoxanthin in the dispersion in %” which is 5.1 in the present case.

### Color Values:

Measured as 5 ppm dispersion in H₂O (1 cm, TTRAN): L*/a*/b*=76/13/−1.3; L*/C*/h=76/13/354.

Measured as 10 ppm dispersion in H₂O (1 cm, TTRAN): L*/a*/b*=59/21/−2.1; L*/C*/h=59/21/354.

### Example 2: Coating of Chocolate Lentil Cores with Rhodoxanthin

The rhodoxanthin dispersion prepared according to example 1 is used as such.

### Example 2-1

The sugar syrup is produced by adding 600 g of sugar, 400 g of water (demineralized) and 10 g of glucose syrup together and heating the mixture up to 105° C. which results in a sugar syrup of 72° Brix.

| Ingredients of the sugar syrup | Amount (g) |
|---|---|
| Raw cane sugar | 600 |
| Water (demineralized) | 400 |
| Glucose Syrup | 10 |

1 g of the rhodoxanthin dispersion according to example 1 are mixed with 500 g of the sugar solution (65-75 Brix, preferred 70-75 Brix) resulting in a colored syrup.

Chocolate lentils are pre-coated with a pure sugar solution thus providing chocolate lentils with a white center. After this pre-coating a white pigment like titanium dioxide may be added to the sugar syrup and the chocolate lentils may be coated with 10-20 layers of this white sugar syrup before they are coated with the colored layers.

A small amount of colored sugar syrup is added to the chocolate lentils and evenly distributed in a panning drum at a moderate speed. Afterwards the thus colored lentils are dried with cold air (15-25° C., relative humidity in the range 30-50%) at moderate speed resulting in one layer. These steps are repeated (usually 20-50 times) until the desired color intensity is achieved. The color values of these colored chocolate lentils are then measured.

| Initial | | | | | | |
|---|---|---|---|---|---|---|
| sample | c/mg/kg | L* | a* | b* | C* | h |
| 2-1 | 14.2 | 60.51 | 19.51 | 1.40 | 19.56 | 4.11 |

### Example 2-2

The sugar syrup is produced by adding 600 g of sugar, 400 g of water (demineralized) and 10 g of glucose syrup together and heating the mixture up to 105° C. which results in a sugar syrup of 72° Brix.

| Ingredients of the sugar syrup | Amount (g) |
|---|---|
| Raw cane sugar | 600 |
| Water (demineralized) | 400 |
| Glucose Syrup | 10 |

2 g of the rhodoxanthin dispersion according to example 1 are mixed with 500 g of the sugar solution (65-75 Brix, preferred 70-75 Brix) resulting in a colored syrup.

Chocolate lentils are pre-coated with a pure sugar solution thus providing chocolate lentils with a white center. After this pre-coating a white pigment like titanium dioxide may be added to the sugar syrup and the chocolate lentils may be coated with 10-20 layers of this white sugar syrup before they are coated with the colored layers.

A small amount of colored sugar syrup is added to the chocolate lentils and evenly distributed in a panning drum at a moderate speed. Afterwards the thus colored lentils are dried with cold air (15-25° C., relative humidity in the range 30-50%) at moderate speed resulting in one layer. These steps are repeated (usually 20-50 times) until the desired color intensity is achieved. The color values of these colored chocolate lentils are then measured.

| Initial | | | | | | |
|---|---|---|---|---|---|---|
| sample | c/mg/kg | L* | a* | b* | C* | h |
| 2-2 | 27 | 51.85 | 21.65 | 2.17 | 21.76 | 5.72 |

### Example 2-3

The sugar syrup is produced by adding 600 g of sugar, 400 g of water (demineralized) and 10 g of glucose syrup together and heating the mixture up to 105° C. which results in a sugar syrup of 72° Brix.

| Ingredients of the sugar syrup | Amount (g) |
|---|---|
| Raw cane sugar | 600 |
| Water (demineralized) | 400 |
| Glucose Syrup | 10 |

3 g of the rhodoxanthin dispersion according to example 1 are mixed with 500 g of the sugar solution (65-75 Brix, preferred 70-75 Brix) resulting in a colored syrup.

Chocolate lentils are pre-coated with a pure sugar solution thus providing chocolate lentils with a white center. After this pre-coating a white pigment like titanium dioxide may be added to the sugar syrup and the chocolate lentils may be coated with 10-20 layers of this white sugar syrup before they are coated with the colored layers.

A small amount of colored sugar syrup is added to the chocolate lentils and evenly distributed in a panning drum at a moderate speed. Afterwards the thus colored lentils are dried with cold air (15-25° C., relative humidity in the range 30-50%) at moderate speed resulting in one layer. These steps are repeated (usually 20-50 times) until the desired color intensity is achieved. The color values of these colored chocolate lentils are then measured.

| Initial | | | | | | |
|---|---|---|---|---|---|---|
| sample | c/mg/kg | L* | a* | b* | C* | h |
| 2-3 | 38.3 | 47.27 | 21.85 | 2.45 | 21.99 | 6.38 |

### Example 3: Measurement of the Color Stability of the Chocolate Lentils According to Examples 2-1, 2-2 and 2-3

The color stability of the colored chocolate lentils are determined over 3 weeks in an accelerated light stability test. The light source in this test is a white light with 800 lux which is applied for 12 hours per day during 3 weeks. The DE* value is calculated as follows:

DE*=\sqrt{(ΔL)²+(Δa)²+(Δb)²}

The DE* for all 3 trials is less than 3 which is not visible for human eyes.

| 3 weeks L*a*b* | | | | | | |
|---|---|---|---|---|---|---|
| values of sample | L* | a* | b* | C* | h | ΔE* |
| 2-1 | 60.90 | 18.67 | 2.22 | 18.80 | 6.78 | 2.03 |
| 2-2 | 53.15 | 20.95 | 3.00 | 21.17 | 8.14 | 1.85 |
| 2-3 | 49.10 | 20.98 | 2.99 | 21.19 | 8.09 | 2.09 |

1.-21. (canceled)

22. A form comprising milled rhodoxanthin, wherein the milled rhodoxanthin in the form has an average particle size in the range of from 400 to 650 nm, measured by Laser Diffraction; Malvern Mastersizer 3000, MIE volume distribution.

23. The form according to claim 22 being a dispersion.

24. The form according to claim 22, wherein the rhodoxanthin is encapsulated in a matrix of modified food starch.

25. The form according to claim 24, further comprising either glycerine or a saccharide.

26. A process for the manufacture of a dispersion according to claim 23 comprising the following steps:
a) Providing a dispersion comprising crystalline rhodoxanthin, modified food starch, water and glycerine or a saccharide;
b) Milling the dispersion as obtained in step a) until the milled rhodoxanthin in the dispersion has an average particle size D(v,0.5) in the range of from 400 to 650 nm, measured by Laser Diffraction; Malvern Mastersizer 3000, MIE volume distribution.

27. A method for coloring edible coatings, sugar syrups or sugar-free syrups, wherein a milled rhodoxanthin form according to claim 22 is used to impart the color to the edible coatings, sugar syrups or sugar-free syrups.

28. An edible coating comprising a form according to claim 22.

29. The edible coating according to according to claim 28, wherein the amount of rhodoxanthin is in the range of from 2 ppm to 100 ppm, based on the total weight of the edible coating.

30. The edible coating according to claim 28, wherein said edible coating has a red value a* in the range of from 15 to 25 at the CIELAB Color scale.

31. The edible coating according to claim 28, wherein said edible coating has a color shade h in the range of from 2 to 10 at the CIELAB Color scale.

32. The edible coating according to claim 28, wherein said edible coating has a color value b* in the range of from 1 to 5 at the CIELAB Color scale.

33. A sugar syrup comprising a sugar and a form according to claim 22.

34. The sugar syrup according to claim 33, wherein the sugar is selected from the group consisting of saccharose, glucose, fructose, maltose and mixtures thereof.

35. A sugar-free syrup comprising a polyol and a form according to claim 22.

36. The sugar-free syrup according to claim 35, wherein the polyol is selected from the group consisting of maltitol, xylitol, mannitol, sorbitol, isomalt, palatinose and mixtures thereof.

37. A panned confection comprising:
a) an edible product center, and
b) an edible coating according to claim 28.
